(19) United States
(12) Patent Application Publication
(10) Pub. No.: US 2009/0023467 A1
(43) Pub. Date: Jan. 22, 2009

(54) METHOD AND APPARATUS FOR PERFORMING SPACE DIVISION MULTIPLE ACCESS IN A WIRELESS COMMUNICATION NETWORK

(76) Inventors: Kaibin HUANG, Hong Kong (HK); Robert W. Heath, JR., Austin, TX (US); Jeffrey G. Andrews, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 12/175,319

(22) Filed: Jul. 17, 2008

Related U.S. Application Data
(60) Provisional application No. 60/950,478, filed on Jul. 18, 2007.

(51) Int. Cl. H04B 7/00

(52) U.S. Cl. 455/522

(57) ABSTRACT

A method and apparatus for performing space division multiple access in wireless communications are disclosed. After the receipt of a set of training data from a base station, an estimated channel state information (CSI) is then generated by a mobile station. The CSI is subsequently quantized. The mobile station then determines whether or not the quantized CSI falls within a set of thresholds. If the quantized CSI falls within the set of thresholds, the mobile then sends feedback information to the base station to allow the base station to consider the mobile station as one of the mobile station candidates available for data communications. Otherwise, if the quantized CSI falls outside the set of thresholds, the mobile station then discards the quantized CSI.

### PRIORITY CLAIM

The present application claims priority under 35 U.S.C. §119(e)(1) to provisional application No. 60/950,478 filed on Jul. 18, 2007, the contents of which are incorporated herein by reference.

### BACKGROUND OF THE INVENTION

1. Technical Field

The present invention relates to wireless communications in general, and, in particular, to a method and apparatus for performing space division multiple access in a wireless communication network.

2. Description of Related Art

Space division multiple access (SDMA) is commonly being referred as multiuser beamforming, multi-input multi-output (MIMO) communication, or multiuser MIMO. Due to its high throughput, SDMA is being considered for the IEEE 802.16e standard. SDMA using transmit beamforming only requires a transmitter having relatively low complexity.

There are many methods for designing SDMA under beamforming constraints, such as zero forcing a signal-to-interference-plus-noise-ratio (SINk) constraint, minimum mean squared error (MMSE), and channel decomposition. However, the performances of SDMA beamforming methods requiring users to be arbitrarily selected tend to be somewhat suboptimal.

SDMA beamforming can be combined with scheduling to improve throughput by exploiting multi-user diversity, which refers to the phenomenon that variations of different users' channels are independent. Typically, joint beamforming and scheduling for SDMA require users to send back their channel state information (CSI). Given that all users share a common feedback channel, the sum feedback rate can rapidly become a bottleneck in a SDMA system having a large number users.

The present disclosure provides an improved method and apparatus for performing SDMA downlinks and uplinks.

### SUMMARY OF THE INVENTION

In accordance with a preferred embodiment of the present invention, after the receipt of a set of training data from a base station, an estimated channel state information (CSI) is then generated by a mobile station. The CSI is subsequently quantized. The mobile station then determines whether or not the quantized CSI falls within a set of thresholds. If the quantized CSI falls within the set of thresholds, the mobile station then sends feedback information to the base station to allow the base station to consider the mobile station as one of the mobile station candidates available for data communications. Otherwise, if the quantized CSI falls outside the set of thresholds, the mobile station then discards the quantized CSI.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a wireless communication network in which a preferred embodiment of the present invention can be incorporated;

FIGS. 2a-2b show quantization regions defined by channel shape and channel power thresholds; and

FIG. 3 is a high-level logic flow diagram of a method for performing space division multiple access in the wireless communication network from FIG. 1, in accordance with a preferred embodiment of the present invention.

### DETAILED DESCRIPTION OF A PREFERRED EMBODIMENT

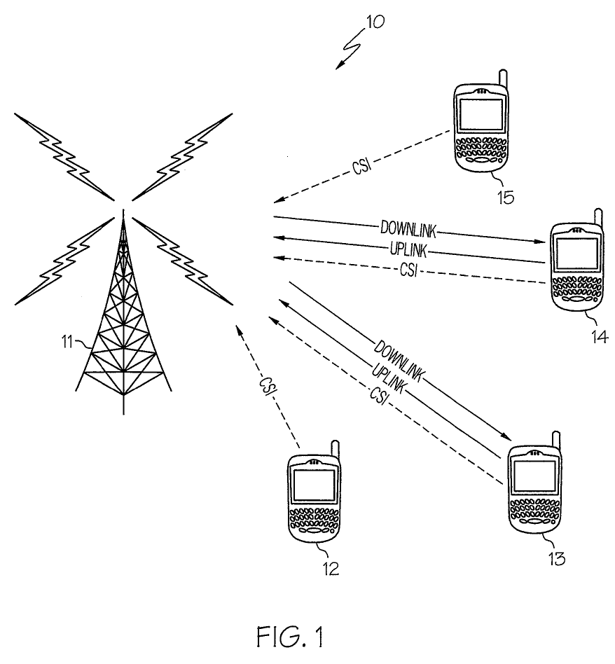

Referring now to the drawings and in particular to FIG. 1, there is depicted a multiple-input-multiple-output (MIMO) communication system in which a preferred embodiment of the present invention can be incorporated. As shown, a MIMO communication system 10 includes a base station 11 that is capable of communicating with multiple mobile stations 12-15. MIMO communication system 10 can handle data transmissions from base station 11 to mobile stations 12-15 and those in the reverse direction. MIMO communication system 10 exploits the spatial degrees of freedom under space division multiple access (SDMA). SDMA supports simultaneous uplink/downlink communications between base station 11 and multiple mobile stations 12-15 in the same time and frequency slots. Compared with the optimal SDMA strategy that uses dirty paper coding, SDMA using transmit beamforming only requires a relatively low complexity transmitter at base station 11.

The throughput of SDMA can be improved by combining SDMA beamforming with scheduling in order to exploit multi-user diversity, which refers to the selection of users with good channels for transmission. The combination of SDMA beamforming and scheduling potentially requires all mobile stations, such as mobile stations 12-15, to send back their channel state information (CSI) to base station 11. Because the sum feedback rate increases linearly with the number of mobile stations within a wireless communication network in which all mobile stations share one single feedback channel, the sum feedback rate can result in an overflow of the feedback channel. In order to solve the bottleneck problem, a sum feedback constraint design of SDMA with beamforming is utilized.

The SDMA design with beamforming under a sum feedback constraint includes (1) a limited feedback module for quantizing CSI of each mobile station and for controlling CSI feedback, (2) a downlink joint beamforming and scheduling module for scheduling users and for selecting transmit beamforming vectors for downlink transmissions, and, optionally, (3) an uplink joint beamforming and scheduling module for uplink transmissions.

### I. Limited Feedback Module

A limited feedback module is used by each mobile station to quantize the estimated downlink CSI into a finite number of bits. Moreover, in order to constrain the sum feedback rate, the limited feedback module applies a set of feedback thresholds to admit a mobile station into the feedback of the quantized CSI.

The need for CSI feedback arises from the fact that without feedback, a base station can at most acquire the CSI of scheduled mobile stations through uplink transmission and channel reciprocity, but scheduling and beamforming potentially rely on the CSI of all mobile stations. The limited feedback module is utilized by each mobile station after the downlink channel has been estimated using pilot symbols (i.e., training data) periodically broadcast by the base station.

Given an antenna array used at the base station and a single antenna by all mobile stations, the instantaneous CSI of each mobile station is a vector with complex coefficients. To facilitate the present description, a channel vector is decomposed into the channel power (the squared vector 2-norm) and the channel shape (the normalized channel vector). The present invention can be easily adjusted to accommodate mobile stations with more than one receive antenna, as it would be clear to those skilled in the art. In this case, the channel is a Nₜ×Nᵣ matrix rather than a Nₜ×1 vector, where there are Nₜ transmit antennas and Nᵣ receiver antennas. For simplicity of exposition, only one receive antenna is utilized to explain the present invention, but it is understood by those skilled in the art that more than one receive antenna can also be utilized.

The limited feedback module has two functions, namely, CSI quantization and feedback control. Specifically, the limited feedback module is used by each mobile station to separately quantize the instantaneous channel power and channel shape. Further performance enhancement can be achieved by jointly quantizing channel power and channel shape using techniques such as product vector quantization. The separate quantization of channel shape and power is motivated by their different feedback purposes, that is, for determining beamforming vectors and for serving as a channel quality indicator, respectively.

The channel shape quantization can be performed by a codebook and a distortion function. The codebook of channel shape quantization includes multiple sets of orthonormal vectors. The codebook is constructed using either one of two following methods: (1) random and independent generations of the orthonormal vector sets, and (2) maximizing the minimum angles between the orthonormal vector sets using a numerical search method. The sub-space distortion function of channel shape quantization measures the projection distance between the original and the quantized channel shapes or equivalently the angle between them. Given the codebook and the distortion function, the operation of channel shape quantization is defined as the operation of selecting from the codebook, the vector that forms the smallest angle with the channel shape and outputs the selected vector as the quantized channel shape.

The codebook for channel power quantization includes a finite set of positive scalars and it is constructed using scalar quantization technique. The distortion function for channel power quantization is chosen to be the square error function, which computes the squared difference between the original and quantized channel power. Similar to channel shape quantization, the channel power quantization is defined as the operation of finding from the codebook a scalar that is closest to the channel power in terms of squared error and then transmitting it as a quantized channel power. Other optimization objectives are also possible, including the absolute value of error (1-norm) or any other distortion metric, but squared error is the easiest to handle analytically.

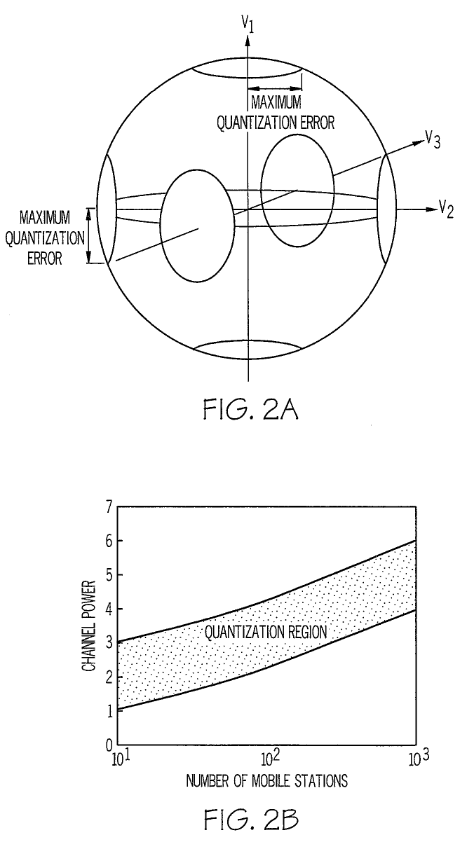

The limited feedback module applies feedback thresholds on the channel shape and the channel power of each mobile station for controlling feedback, thereby satisfying a sum feedback rate constraint. A mobile station transmits indices of quantized channel shape and channel power to the base station via the feedback channel if the mobile station satisfies certain criteria of feedback thresholds. The feedback threshold for the channel shape ensures that the channel shape quantization error of a mobile station sending feedback is small, avoiding strong interference between scheduled mobile stations due to high inaccuracy of channel shape feedback. The threshold that defines a channel shape quantization region is illustrated in FIG. 2a for the case of a real channel vector. Next, a pair of lower and upper feedback thresholds for channel power are also used by each mobile station, which defines the range of channel power of feedback users, as illustrated in FIG. 2b. Due to the use of multiple antennas at the base station, the channel coefficients of a mobile station can be represented by a vector. For example, a channel shape is a normalized channel vector, and the channel power is the squared norm of the channel vector.

Note that all feedback thresholds are functions of the number of mobile stations. The lower channel power threshold selects feedback mobile stations with sufficiently high channel power to achieve a high throughput since scheduled mobile stations are a subset of feedback mobile stations. Moreover, the upper threshold prevents feedback mobile stations from having too strong channel power that causes strong multi-user interference in the uplink channel. The feedback thresholds for both the channel shape and the channel power are designed to satisfy a sum feedback rate constraint, that is, the average sum CSI feedback rate is upper bounded by a constant determined by the bandwidth of the feedback channel. Consider the case when mobile stations access the feedback channel using a random-access protocol, the enforcement of a sum feedback rate can reduce the overflow probability of the feedback channel to be close to zero, and thus, a stable system is maintained.

### II. Downlink Joint Beamforming and Scheduling Module

At the base station, using multi-user feedback CSI, the downlink joint beamforming and scheduling module is utilized to select downlink mobile stations and their transmit beamforming vectors so as to maximize the downlink throughput. The downlink joint beamforming and scheduling module effectively reduces the mutual interference between scheduled mobile stations caused by the inaccuracy of feedback CSI, which results in a higher downlink throughput.

The downlink joint beamforming and scheduling module works with the limited feedback module to enable downlink SDMA under the sum feedback rate constraint. Specifically, based on the feedback CSI attained using the limited feedback module, the downlink joint beamforming and scheduling module in the base station selects a subset of feedback users and computes their orthogonal beamforming vectors for subsequent downlink transmissions. The downlink joint beamforming and scheduling module has a relatively low complexity since it requires neither an exhaustive search nor complicated beamforming operations such as zero-forcing that involves matrix inversion and multiplication. Furthermore, the downlink joint beamforming and scheduling module incurs no throughput loss with respect to the case of all mobile stations sending feedbacks.

Downlink joint beamforming and scheduling module perform the following functions. Mobile stations are initially divided into sub-groups according to their quantized channel shapes, and each sub-group of mobile stations corresponds to a specific vector in a channel shape quantization codebook. Among the mobile stations in a sub-group, the one with the maximum signal-to-noise-interference ratio (SNIR), which is computed using quantized channel shape and channel power, is selected and assigned to the codebook vector identifying this sub-group of mobile stations. As a result of this maximum SNIR selection process, each vector in the channel shape codebook is assigned to a unique mobile station.

By design, the vectors in the channel shape quantization codebook are multiple sets of orthonormal vectors. For each set of orthonormal vector, the sum capacity of mobile stations assigned to these vectors is computed. Subsequently, the orthonormal vector set related to the maximum sum capacity is chosen as downlink orthogonal beamforming vectors. Furthermore, the mobile stations assigned to these chosen vectors are scheduled for downlink transmission using corresponding beamforming vectors.

### III. Uplink Joint Beamforming and Scheduling Module

An uplink joint beamforming and scheduling module can exploit channel reciprocity, and the feedback downlink CSI is utilized to select uplink mobile stations and to receive beamforming vectors for separating multi-user data streams at the base station. The presence of channel reciprocity results in identical channel coefficients between the uplink and downlink channels. Thus, the downlink multi-user CST acquired at the base station using the limited feedback module can be also applied for the uplink joint beamforming and scheduling module. In other words, by exploiting the channel reciprocity, the same limited feedback module can work with both the downlink and uplink beamforming and scheduling modules. For the case of reciprocal channels, an uplink joint beamforming and scheduling module that has low complexity and achieves high throughput under the sum feedback rate constraint can be applied. The method utilized by the uplink module is similar to the above-mentioned downlink counterpart.

There are some differences between the uplink and downlink joint beamforming and scheduling modules. First, the beamforming vectors generated by the uplink and downlink module are used respectively for receive and transmit beamforming. Second, in the uplink module, SNIR lower bounds rather than the actual SNIRs are used as a metric for selecting uplink users and orthogonal beamforming vectors. The reason is that the SNIRs for uplink SDMA are difficult to compute given scheduled mobile stations are unknown, but this difficulty does not exist for downlink SDMA.

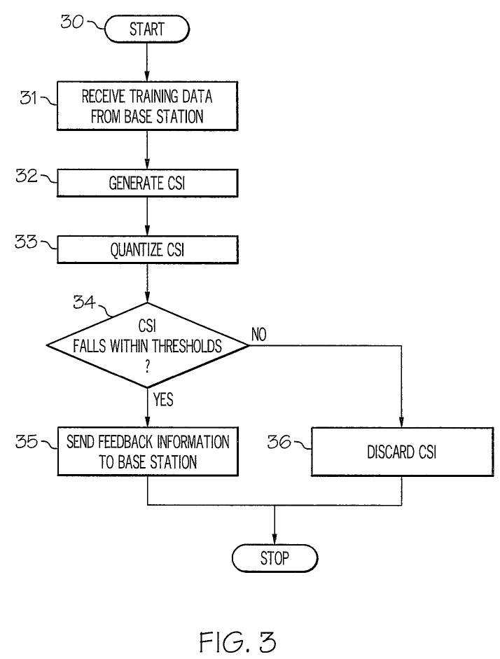

Referring now to FIG. 3, there is depicted a high-level logic flow diagram of a method for performing SDMA in a wireless communication network, such as wireless communication network 10 from FIG. 1, in accordance with a preferred embodiment of the present invention. Starting at block 30, a set of training data is initially sent from a base station, such as base station 11 from FIG. 1, to multiple mobile stations, such as mobile stations 12-15 from FIG. 1, as shown in block 31. After the receipt of the training data, each of the mobile stations then generates an estimated CSI, as depicted in block 32. The CSI is subsequently quantized by each of the mobile stations accordingly, as shown in block 33. As mentioned previously, a channel vector can be separated into channel shape (i.e., quantization error) and channel power (i.e., SNIR). A shape quantizer and a shape codebook are utilized to quantize the channel shape of the CSI. A power quantizer and a power codebook are utilized to quantize the channel power of the CSI.

Each of the mobile stations then determines whether or not the quantized CSI falls within a set of thresholds, as depicted in block 34. The set of thresholds may include, 1l for example, a channel power threshold and a channel shape threshold. If the quantized CSI of a mobile station falls within the set of thresholds, the mobile station then sends feedback information to the base station to allow the base station to consider the mobile station as one of the mobile station candidates available for data communications, as shown in block 35. Otherwise, if the quantized CSI falls outside the set of thresholds, the mobile station then discards the quantized CSI, as depicted in block 36.

Continued with the above-mentioned example, if a mobile station determines that the quantized CSI is greater than (or equal to) the channel power threshold and less than (or equal to) the channel shape threshold, the mobile station sends feedback information to the base station. Otherwise, the mobile station discards the quantized CSI.

Only a subset of mobile stations that satisfies the feedback thresholds will send feedback information to the base station. Each mobile station that qualifies for sending feedback information transmits the respective indices of quantized channel shape and channel power to the base station via a feedback channel and follows by, for example, a random access protocol. The feedback information of each feedback mobile station requires only a few bits since the CSI quantization codebooks are relatively small in sizes. Using the codebook known a priori, the base station converts the feedback indices of different mobile stations into their respective quantized CSI (i.e., channel shape and channel power). Subsequently, the base station uses the quantized CSI for either downlink or uplink joint beamforming and scheduling.

As has been described, the present invention provides a method and apparatus for performing SDMA downlinks and uplinks with a bounded sum feedback rate.

It is also important to note that although the present invention has been described in the context of a wireless communication system, those skilled in the art will appreciate that the mechanisms of the present invention are capable of being distributed as a program product in a computer storage readable medium. In addition, although the present invention focused on multi-antenna systems in wireless communications, the present invention can also apply to multi-input (and single or multi-output) wired communication systems.

While the invention has been particularly shown and described with reference to a preferred embodiment, it will be understood by those skilled in the art that various changes in form and detail may be made therein without departing from the spirit and scope of the invention.

What is claimed is:

1. A mobile station comprising:
means for, in response to the receipt of training data from a base station, generating channel state information (CSI);
a quantizer for quantizing said CSI;
means for determining whether or not said quantized CSI falls within a set of thresholds; and
means for, in response to a determination that said quantized CSI falls within said set of thresholds, sending feedback information to said base station to allow said mobile station to be considered by said base station for initiating data communications with said mobile station.

2. The mobile station of claim 1, wherein said set of thresholds includes a channel power threshold and a channel shape threshold.

3. The mobile station of claim 2, wherein said means for determining further includes means for determining whether or not said quantized CSI is greater than said channel power threshold and less than said channel shape threshold.

4. The mobile station of claim 1, wherein said mobile station further includes means for, in response to a determination that said quantized CSI falls outside said set of thresholds, discarding said quantized CSI.

5. A method for performing space division multiple access in a wireless communication network, said method comprising:
in response to the receipt of training data from a base station, generating channel state information (CSI);
quantizing said CSI;
determining whether or not said quantized CSI falls within a set of thresholds; and
in response to a determination that said quantized CSI falls within said set of thresholds, sending feedback information to said base station to allow said mobile station to be considered by said base station for initiating data communication with said mobile station.

6. The method of claim 5, wherein said set of thresholds includes a channel power threshold and a channel shape threshold.

7. The method of claim 6, wherein said determining further includes determining whether or not said quantized CSI is greater than said channel power threshold and less than said channel shape threshold.

8. The method of claim 5, wherein said method further includes in response to a determination that said quantized CSI falls outside said set of thresholds, discarding said quantized CSI.

9. A base station comprising:
means for sending a set of training data to a plurality of mobile stations;
in response to the receipt of feedback information from one or more of said mobile stations, adding said one or more mobile stations to a selection pool, wherein said feedback information is formulated by said one or more mobile stations based on said set of training data; and
selecting a subset of said one or more mobile stations for receiving data.

10. The base station of claim 9, wherein said one or more mobile stations send said feedback information to said base station when a set of quantized CSI is greater than a channel power threshold and less than a channel shape threshold, wherein said set of quantized CSI is generated based on said set of training data.
